(19) United States
(12) Patent Application Publication
(10) Pub. No.: US 2006/0139811 A1
(43) Pub. Date: Jun. 29, 2006

(54) Suspension and actuator with the same for use in hard disk drive

(75) Inventors: Seung-young Yi, Suwon-si (KR); Tae-sik Kang, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/213,943

(22) Filed: Aug. 30, 2005

(30) Foreign Application Priority Data
Dec. 28, 2004 (KR) 10-2004-0113694

(51) Int. Cl. G11B 5/48

(52) U.S. Cl. 360/245

(57) ABSTRACT

A suspension and an actuator with the same for a hard disk drive. A suspension includes a load beam having one end portion coupled to a swing arm and another end portion from which a dimple protrudes in a direction toward a disk, and a flexure having one end portion fixed to a surface of the load beam opposing the disk and another end portion in contact with the dimple. A part of the another end portion of the load beam from the dimple in a direction away from the one end portion is bent in a direction opposite to a protruding direction of the dimple, so as to widen a space between the another end portion of the load beam and the another end portion of the flexure.

### CROSS-REFERENCE TO RELATED APPLICATION

This application claims the benefit of Korean Patent Application No. 2004-0113694, filed on Dec. 28, 2004, in the Korean Intellectual Property Office, the disclosure of which is incorporated herein by reference.

### BACKGROUND OF THE INVENTION

1. Field of the Invention

The present invention relates to an actuator for a hard disk drive, and more particularly, to a suspension capable of reducing disturbance of a magnetic head slider, and an actuator having the suspension.

2. Description of Related Art

A hard disk drive is an auxiliary memory unit for a personal computer to read data from a disk or write data on the disk, by use of a magnetic head mounted to a magnetic head slider. During operation of the hard disk drive, the magnetic head slider is floated at a certain interval relative to the disk. The magnetic head reads the data from the disk or writes the data on the disk.

FIG. 1 is a perspective view of a suspension of a conventional actuator.

Referring to FIG. 1, an actuator 10 includes a swing arm 11 rotatably installed to a base plate (not shown), and a suspension 20 fixed to an end portion of the swing arm 11 for biasing a magnetic head slider 30 towards a surface of the disk (not shown). The suspension 20 has a load beam 21 with one end portion engaged to the swing arm 11, and a flexure 25 with one end portion engaged to the load beam 21. The other end portion of the flexure 25 is a free end portion, and supports the magnetic head slider 30. The other end portion of the flexure 25 contacts with a dimple 23 protruded from one side of the load beam 21 and is supported by the dimple 23. Accordingly, the other end portion of the flexure 25 is provided with a clearance in which the flexure is pitched and rolled relative to the other end portion of the load beam 21.

When the disk is turned at high speed on the base plate, a lift force acts on the magnetic head slider 30. The magnetic head slider 30 is floated over the surface of the disk at a certain height by balance of the lift force and a biasing force of the load beam 21 biased towards the disk. In this state, a magnetic head (not shown) provided to magnetic head slider 30 functions to write the data on a recording surface of the disk or read the data from the recording surface of the disk 115.

Meanwhile, if a disturbance is applied to the conventional actuator 10 in the state where the magnetic head slider 30 is floating, the other end portion of the load beam 21 is shaken up and down to collide against the other end portion of the flexure 25. As a result, there is a problem in that the magnetic head slider 30 may not keep the floating state, and collide against the disk. In order to solve the above problem, a method of raising a protruded height of the dimple 23 has been proposed. There is however a drawback in that it is difficult to horizontally maintain a rolling angle of the magnetic head slider 30. Accordingly, maintenance of the floating is also difficult.

### BRIEF SUMMARY

An aspect of the present invention provides an improved suspension capable of reducing a possibility of colliding a load beam against a flexure in spite of disturbance acting on a head disk drive, and an actuator having the same.

According to an aspect of the present invention, there is provided a suspension including a load beam having one end portion coupled to a swing arm and another end portion from which a dimple protrudes in a direction toward a disk, and a flexure having one end portion fixed to a surface of the load beam opposing the disk and another end portion in contact with the dimple. A part of the another end portion of the load beam from the dimple in a direction away from the one end portion is bent in a direction opposite to a protruding direction of the dimple, so as to widen a space between the another end portion of the load beam and the another end portion of the flexure.

The load beam may be bent near the protruding position of the dimple in a direction opposite to the protruding direction of the dimple.

The load beam may be again bent to form a stepped portion at the other end portion thereof.

A width of the load beam at the rear of the protruding position of the dimple may be smaller than a width of the flexure.

According to another aspect of the present invention, there is provided a suspension including a load beam having one end portion coupled to a swing arm and another end portion from which a dimple protrudes in a direction toward a disk, and a flexure having one end portion fixed to a surface of the load beam opposing the disk and another end portion in contact with the dimple. A width of a part of the another end portion of the load beam from the dimple in a direction away from the one end portion is smaller than a width of the flexure.

According to further another aspect of the present invention, there is provided an actuator including a magnetic head slider, a suspension attaching and supporting the magnetic head slider, and a swing arm rotatably installed to a base plate of a hard disk drive supporting the suspension. The suspension includes a load beam having one end portion coupled to the swing arm and another end portion from which a dimple protrudes in a direction toward a disk, and a flexure having one end portion fixed to a surface of the load beam opposing the disk and another end portion in contact with the dimple. A part of the another end portion of the load beam from the dimple in a direction away from the one end part is bent in a direction opposite to a protruding direction of the dimple, so as to widen a space between the another end portion of the load beam and the another end portion of the flexure.

The load beam may be bent near the protruding position of the dimple in a direction opposite to the protruding direction of the dimple.

The load beam may be again bent to form a stepped portion at the other end portion thereof.

A width of the load beam at the rear of the protruding position of the dimple may be smaller than a width of the flexure.

According to still another aspect of the present invention, there is provided an actuator including a magnetic head slider, a suspension attaching and supporting the magnetic head slider, and a swing arm rotatably installed to a base plate of a hard disk drive supporting the suspension. The suspension includes a load beam having one end portion coupled to the swing arm and another end portion from which a dimple protrudes in a direction toward a disk, and a flexure having one end portion fixed to a surface of the load beam opposing the disk and another end portion in contact with the dimple. A width of a part of the another end portion of the load beam from the dimple in a direction away from the one end portion is smaller than a width of the flexure.

According to another aspect of the present invention, there is provided a suspension including: a load beam having a first end coupled to a swing arm and a second end from which a dimple protrudes; and a flexure having a first end connected to the load beam at a side of the load beam from which the dimple protrudes and a second end in contact with the dimple. A portion of the second end of the load beam distal from the swing arm is bent in a direction opposite to a direction in which the dimple protrudes so as to increase a space between the second ends.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a perspective of a suspension of a conventional actuator;

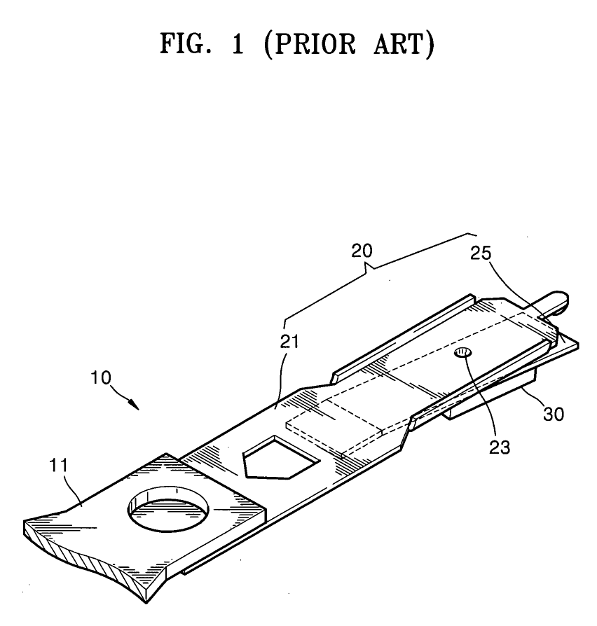

FIG. 2 is a plan view of a hard disk drive having an actuator of a first embodiment of the present invention;

FIGS. 3 and 4 are a perspective view and a side view illustrating a suspension provided to the actuator shown in FIG. 2; and

FIGS. 5 and 6 are a perspective view and a plan view illustrating a suspension provided to an actuator according to a second embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

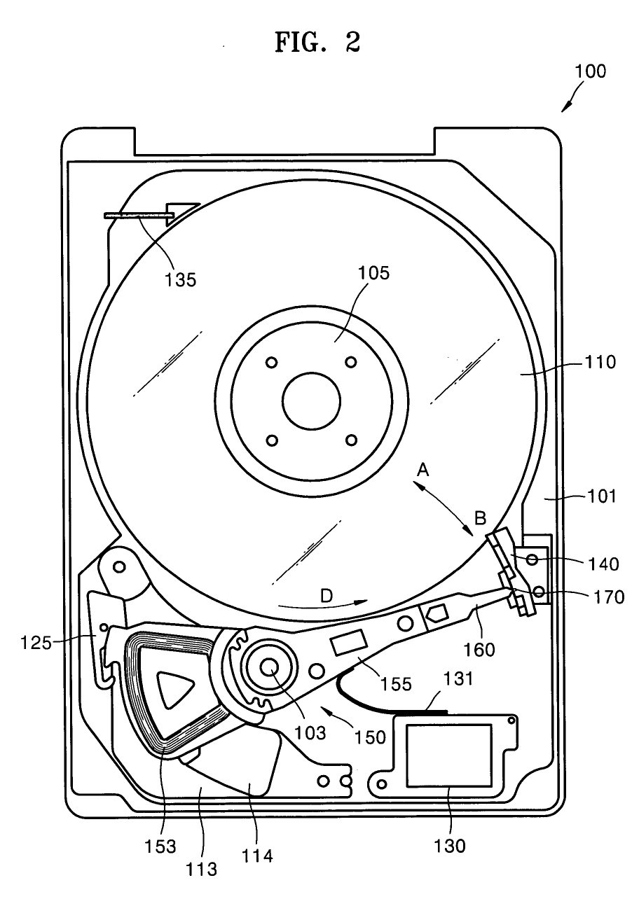

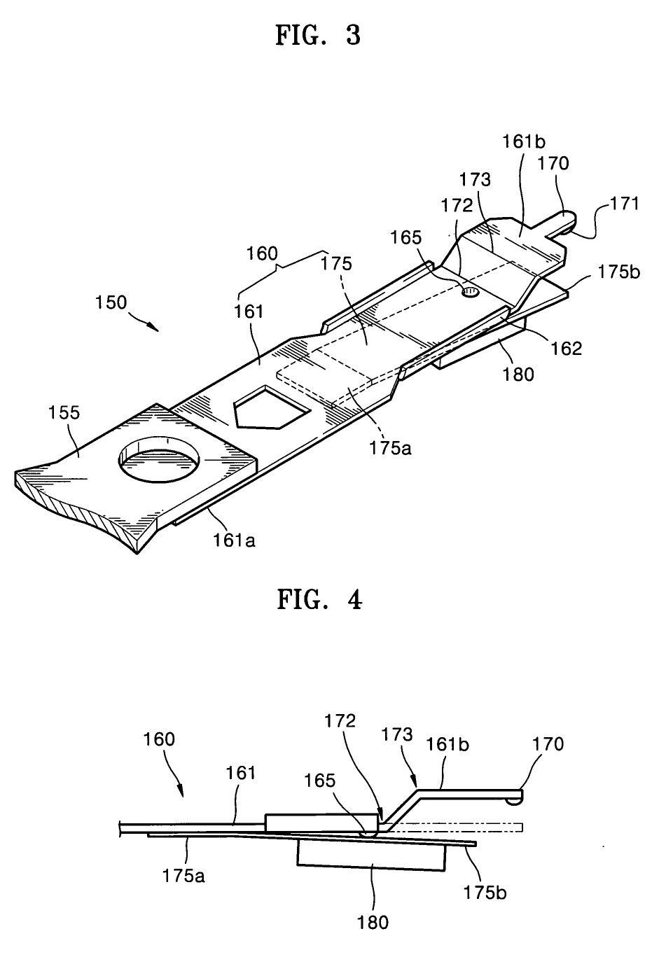

FIG. 2 is a plan view of a hard disk drive having an actuator of a first embodiment of the present invention. FIGS. 3 and 4 are a perspective view and a side view illustrating a suspension provided to the actuator shown in FIG. 2.

Referring to FIGS. 2 through 4, a hard disk drive 100 includes a spindle motor 105 fixed to a base plate 101, a disk 110 fixed to the spindle motor 105 and rotated relative to the base plate 101, and an actuator 150 for transferring a magnetic head slider 180 to a desired position on the disk 110. The base plate 101 couples a cover plate (not shown) to define a sealed internal space, in which the disk 110, the actuator 150 and the like are accommodated.

The actuator 150 has a swing arm 155 rotatably installed to a pivot shaft 103 provided to the base plate 101, and a suspension 160 fixed to an end portion of the swing arm 155 for biasing a magnetic head slider 180 towards a surface of the disk 110.

The suspension 160 has a load beam 161 and a flexure 175. The load beam 161 has one end portion 161a coupled to a front end portion of the swing arm 155. The load beam 161 is generally manufactured by pressing a metal plate, such as stainless steel, having a thin thickness, for example, about 0.05 mm. Both edges 162 of the load beam 161 are bent upwardly to increase its rigidity.

The flexure 175 supports the magnetic head slider 180, and is attached to one side of the load beam 161 opposite to the disk 110. One end portion 175a of the flexure 175 is a stationary end, and is fixed to a portion of the load beam 161 opposite to the disk by welding. The other end portion 175b of the flexure 175 is a free end portion, and is positioned at the other end portion 161b of the load beam 161. The flexure 175 is made of a thin stainless steel plate as the load beam 161. The flexure 175 has a thickness thinner than that of the load beam 161, for example, about 0.02 mm, such that the magnetic head slider 180 supported by the flexure is smoothly rolled and pitched.

A dimple 165 protrudes from the other end portion 161b of the load beam 161 towards the flexure 175. The other end portion 175b of the flexure 175 is in contact with the dimple 165, and is supported by the dimple 165. Accordingly, the other end portion 175b of the flexure 175 is spaced apart from the other end portion 161b of the load beam 161, such that the magnetic head slider 180 may be smoothly pitched and rolled relative to the other end portion 161b of the load beam 161 during operation of the hard disk drive 100.

A voice coil motor (VCM) fixed to the base plate 101 supplies a rotational force to the actuator 150. The voice coil motor includes a lower yoke 113 disposed under a coil 153 of the actuator 150, and a magnet 114 attached to an upper surface of the lower yoke 113. Although not shown in the accompanying drawings, the voice coil motor may include an upper yoke disposed above the coil 153 of the actuator 150, and a magnet attached to a lower surface of the upper yoke. The voice coil motor is controlled by a servo control system, and rotates the actuator 150 in a direction according to Fleming's left-hand rule due to interaction of magnetic field induced by the magnet 114 and current applied to the coil 153.

The hard disk drive 100 includes a ramp 140 at an outside of the disk 110. An end tap 170 is extended from an end portion of the load beam 161 of the actuator 150, and is in contact with the ramp 140 to be supported by the ramp. The end tap 170 generally has a convex boss 171 protruding towards a support surface of the ramp 140 so as to reduce a contact area between the end tap and the support surface. In the state where the hard disk drive 100 does not operate, the actuator 150 is parked out of the surface of the disk 110, as shown in FIG. 2. At that time, the end-tap 170 is supported by the ramp 140.

If the actuator 150 is released from the parking state and optionally rotates, the magnetic head slider 180 and the disk 110 may touch with each other and cause damage. Therefore, the actuator 150 has to be locked so as to prevent the optional rotation. To this end, the hard disk drive 100 includes an actuator latch 125.

The base plate 101 is provided at one corner thereof with an FPC bracket 130 for connecting a flexible printed circuit (FPC) 131 which is connected to the actuator 150 to a printed circuit board (not shown) disposed under the base plate 101. Also, a circulation filter 135 for filtering foreign substance, such as particles, contained in air flowing in the hard disk drive 100 is provided at the other corner diagonally opposite to the one corner.

If a power is applied to the hard disk drive 100, the disk 110 is turned in a direction of an arrow D, and the voice coil motor rotates the actuator 150 parked at the ramp 140 in a direction of an arrow A to transfer the magnetic head slider 180 over the surface of the disk 110. The magnetic head slider 180 is floated from the surface of the disk 110 at a certain height by balance of a lift force produced from flow of the air induced by the rotation of the disk 110 and a biasing force of the load beam 161 towards the surface of the disk 110. In this state, the actuator 150 moves the magnetic head slider 180 a certain position on the disk 110 to enable a magnetic head (not shown) to write the data on the disk 110 or read the data from the disk 110.

If the power of the hard disk drive 100 is turned off, the voice coil motor rotates the actuator 150 in a direction of an arrow B, and the actuator 150 is laid on and supported by the ramp 140, so that the actuator is parked.

The other end portion 161b of the load beam 161 is bent in a direction opposite to a protruding direction of the dimple 165 at a first bending position 172 at the rear of a protruding position of the dimple 165, and is again bent at a second bending position 173 near a front end of the load beam to form a stepped portion. As shown in FIGS. 3 and 4, the first bending position 172 may be formed at a position very close to the protruding position of the dimple 165. As a result, a clearance formed between the other end portion 175a of the flexure 175 and the other end portion 161b of the load beam 161 is more widened relative to a conventional case indicated by an imaginary line in FIG. 4. Accordingly, even though disturbance is transferred to the hard disk drive 100 and thus the other end portion 161 of the load beam 161 is shaken up and down, a possibility that the other end portion 161b of the load beam 161 colliding against the other end portion 175b of the flexure 175 is remarkably reduced. Meanwhile, the other end portion 161b of the load beam 161 is angularly bent, as shown in FIGS. 3 and 4, but the other end portion may be bent in a smooth curve.

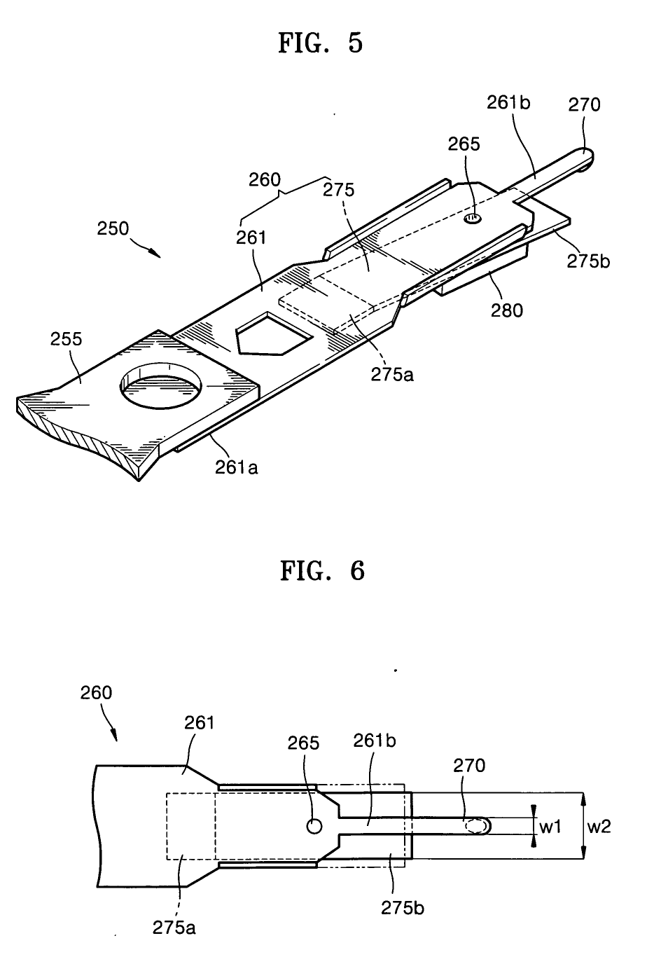

FIGS. 5 and 6 are a perspective view and a plan view illustrating a suspension provided to an actuator according to a second embodiment of the present invention. The actuator according to the second embodiment of the present invention may be installed to the hard disk drive 100 shown in FIG. 2, instead of the actuator 150 according to the first embodiment of the present invention.

Referring to FIGS. 5 and 6, the actuator 250 has a swing arm 255 rotatably installed to a base plate 101 (FIG. 2), and a suspension 260 fixed to an end portion of the swing arm 255 for supporting a magnetic head slider 280. The suspension 260 has a load beam 261 having one end portion 261a coupled to a front end portion of the swing arm 255, and a flexure 275 for attaching and supporting the magnetic head slider 280.

One end portion 275a of the flexure 275 is a stationary end fixed to a portion of the load beam 261 opposite to the disk by welding. The other end portion 275b of the flexure 275 is a free end portion, and is positioned at the other end portion 261b of the load beam 261. A dimple 265 is protruded from the other end portion 261b of the load beam 261 towards the flexure 275. The other end portion 275b of the flexure 275 is in contact with the dimple 265, and is supported by the dimple 265.

In the load beam 261, a width W1 of the other end portion 261b at the rear of a protruding position of the dimple 265 is smaller than a width W2 of the flexure 275. In the embodiment shown in FIG. 6, the width W1 of the other narrower end portion 261b of the load beam 261 is equal to a width of the end tap 270, but the width W1 may be different from the width of the end tap. Accordingly, even though disturbance is transferred to the hard disk drive 100 and thus the other end portion 261b of the load beam 261 is fluctuated up and down, a possibility that the other end portion 261b of the load beam 261 collides against the other end portion 275b of the flexure 275 is remarkably reduced. Meanwhile, the other end portion of a conventional load beam shown by an imaginary (hashed) line in FIG. 6 is widely rolled when the disturbance is transferred to the hard disk drive, such that the other end portion of the load beam may likely collide against the other end portion 275b of the flexure 275. However, since the other end portion 261b of the load beam 261 according to the second embodiment has the narrow width W1, a width of rolling induced by the same disturbance is small, thereby reducing a possibility of collision between the other end portion 261b of the load beam 261 and the other end portion 275b of the flexure 275.

The characteristics of the present invention provided by the above first and second embodiments are not exclusive to each other. In other words, the present invention may include a suspension having a load beam with the other end being bent and having a width narrower than a width of the flexure.

With such a suspension and an actuator having the same, the possibility of collision between the load beam and the flexure due to the disturbance is reduced relative to the conventional suspension. Accordingly, the embodiments of the present invention can minimize the risk that the disk damages by colliding the magnetic head slider against the disk.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A suspension including a load beam having one end portion coupled to a swing arm and another end portion from which a dimple protrudes in a direction toward a disk, and a flexure having one end portion fixed to a surface of the load beam opposing the disk and another end portion in contact with the dimple,
wherein a part of the another end portion of the load beam from the dimple in a direction away from the one end portion is bent in a direction opposite to a protruding direction of the dimple, so as to widen a space between the another end portion of the load beam and the another end portion of the flexure.

2. The suspension according to claim 1, wherein the load beam is bent near the dimple in a direction opposite to the protruding direction of the dimple.

3. The suspension according to claim 1, wherein the load beam is again bent to form a stepped portion at the part of the another end portion.

4. The suspension according to claim 1, wherein a width of a part of the another end portion of the load beam from the dimple in a direction away from the one end portion is smaller than a width of the flexure.

5. A suspension including a load beam having one end portion coupled to a swing arm and another end portion from which a dimple protrudes in a direction toward a disk, and a flexure having one end portion fixed to a surface of the load beam opposing the disk and another end portion in contact with the dimple,
wherein a width of a part of the another end portion of the load beam from the dimple in a direction away from the one end portion is smaller than a width of the flexure.

6. An actuator including a magnetic head slider, a suspension attaching and supporting the magnetic head slider, and a swing arm rotatably installed to a base plate of a hard disk drive supporting the suspension,
wherein the suspension includes a load beam having one end portion coupled to the swing arm and another end portion from which a dimple protrudes in a direction toward a disk, and a flexure having one end portion fixed to a surface of the load beam opposing the disk and another end portion in contact with the dimple,
wherein a part of the another end portion of the load beam from the dimple in a direction away from the one end part is bent in a direction opposite to a protruding direction of the dimple, so as to widen a space between the another end portion of the load beam and the another end portion of the flexure.

7. The actuator according to claim 6, wherein the load beam is bent near the dimple in a direction opposite to the protruding direction of the dimple.

8. The actuator according to claim 6, wherein the load beam is again bent to form a stepped portion at the part of the another end portion.

9. The actuator according to claim 6, wherein a width of a section of the another end portion of the load beam from the dimple in a direction away from the one end portion is smaller than a width of the flexure.

10. An actuator including a magnetic head slider, a suspension attaching and supporting the magnetic head slider, and a swing arm rotatably installed to a base plate of a hard disk drive supporting the suspension,
wherein the suspension includes a load beam having one end portion coupled to the swing arm and another end portion from which a dimple protrudes in a direction toward a disk, and a flexure having one end portion fixed to a surface of the load beam opposing the disk and another end portion in contact with the dimple, and
wherein a width of a part of the another end portion of the load beam from the dimple in a direction away from the one end portion is smaller than a width of the flexure.

11. A suspension comprising:
a load beam having a first end coupled to a swing arm and a second end from which a dimple protrudes; and
a flexure having a first end connected to the load beam at a side of the load beam from which the dimple protrudes and a second end in contact with the dimple,
wherein a portion of the second end of the load beam distal from the swing arm is bent in a direction opposite to a direction in which the dimple protrudes so as to increase a space between the second ends.
